(19) United States
(12) Patent Application Publication
(10) Pub. No.: US 2011/0030670 A1
(43) Pub. Date: Feb. 10, 2011

(54) PORTABLE ANTI-SCORCHING ROASTING CAN

(76) Inventor: KUO-CHENG PENG, Hsinchu (TW)

Correspondence Address: DING YU TAN, Chengde Road, Sec 1, #83, 3F-1, Taipei, TW

(21) Appl. No.: 12/824,233

(22) Filed: Jun. 28, 2010

(30) Foreign Application Priority Data
Aug. 4, 2009 (TW) 098126185

(51) Int. Cl. A47J 37/07

(52) U.S. Cl. 126/25 A

(57) ABSTRACT

A portable anti-scorching roasting can includes a can body, at least one segregating cage, a cover, a pivoting element, a combining element, and a handle. The can body has an open end and a containing space. The segregating cage has a plurality of openings. The segregating cage located in the containing space is used to contain the foodstuff. The pivoting element is located between the cover and the can body. By using the pivoting element, user can open or close the cover at the open end of the can body. The combining element is located between the pivoting element and the can body. By using the combining element, the pivoting element, which is connected to the cover, is combined into the can body. The handle has a connecting portion which is connected with the cover, and has a handle grip which is made of thermal insulating material.

### FIELD OF INVENTION

The present invention relates to a portable anti-scorching roasting can, and especially relates to a portable anti-scorching roasting can that cooks food by roasting method in order to prevent the food from becoming scorched.

### BACKGROUND OF THE INVENTION

Going to a barbecue cookout is usually a gathering event for friends and family. Nowadays, when taking part in a barbecue activity, the uncooked food is placed on the grill and the grill is held above the fire. Oil and grease are easily dripped from the heated foodstuff. As the oil or grease is dropped into the fire, it would cause a fire, which will burn in an upward direction and to be contacted with the foodstuff. Therefore, the foodstuff is easily scorched thus producing carcinogens. Furthermore, even for vegetables that do not easily drip grease, the barbequed vegetables will be scorched because of the excessive temperatures when it is placed close to the fire.

In recent years, the concept of healthy living is getting more and more attention to the public. In order to avoid eating charred and scorched food, some people try to carefully pick out certain special healthier foodstuff that produce lesser carcinogen, and to another extreme, some other people just give up the barbecue activity altogether. Hence, there is a need in the art for segregating or isolating the foodstuff from the fire during a barbecue.

### SUMMARY OF THE INVENTION

One object of the present invention is to provide a portable anti-scorching roasting can. The foodstuff, which is placed inside the portable anti-scorching roasting can, may be roasted over fire in an indirect manner, so as to replace the conventional barbecue method. Because of not being in close contact with the fire, the foodstuff is not easily scorched and does not produce carcinogen.

To achieve the foregoing and other object, a portable anti-scorching roasting can is disclosed. The portable anti-scorching roasting can includes a can body, at least a segregating cage, a cover, a pivoting element, a combining element, and a handle. The can body has an open end and a containing space. The segregating cage has a plurality of openings. The segregating cage is located in the containing space and used to contain the foodstuff. The pivoting element is located between the cover and the can body. By using the pivoting element, a user can open or close the cover at the open end of the can body. The combining element is located between the pivoting element and the can body. By using the combining element, the pivoting element, which is connected to the cover, is combined into the can body. The handle has a connecting portion and a handle grip. The connecting portion is connected with the cover; and the handle grip is made of thermal insulating material. After putting the foodstuff inside the can body and closing the cover at the open end, the foodstuff can be roasted inside the can body. Because of being not in contact with the fire, the foodstuff is prevented from becoming scorched.

In the portable anti-scorching roasting can, a grease discharge hole is formed on a bottom surface of the can body. Furthermore, a longitudinal rod is located/disposed at the center of the one circular end of the segregating cage. When the segregating cage is placed in the can body, the longitudinal rod is passed through the grease discharge hole. When the user wants to take out the segregating cage to be washed, he/she only needs to perpendicularly or vertically tap the can body against the ground or similar solid surfaces, and then the longitudinal rod will be abutted against the ground, and the top end of the segregating cage will be ejected from the open end of the can body. Thereafter, by using a clamping tool, the user can take out the segregating cage.

Therefore, the portable anti-scorching roasting can not only avoid the foodstuff becoming scorched, but also provide safety and convenience features and properties.

In addition, the combing element is made of a bolt and a nut. When the can body is no longer suitable for use anymore, by using a screwdriver, the user can quickly replace the old can body with a new one.

The above and other aspects, features, and advantages of the present invention will become more apparent from the following detailed description when taken in conjunction with the accompanying drawings.

### BRIEF DESCRIPTION OF THE DRAWINGS

FIG. 1 shows the exploded view of the portable anti-scorching roasting can in the present embodiment of the invention.

FIG. 2 shows the perspective view of the portable anti-scorching roasting can in the present embodiment of the invention.

FIG. 3 shows the sectional view of the portable anti-scorching roasting can in the present embodiment of the invention.

FIG. 4 shows the use of the portable anti-scorching roasting can in the present embodiment.

FIG. 5 shows the state of the segregating cage when detached from the can body.

### DETAILED DESCRIPTION OF THE INVENTION

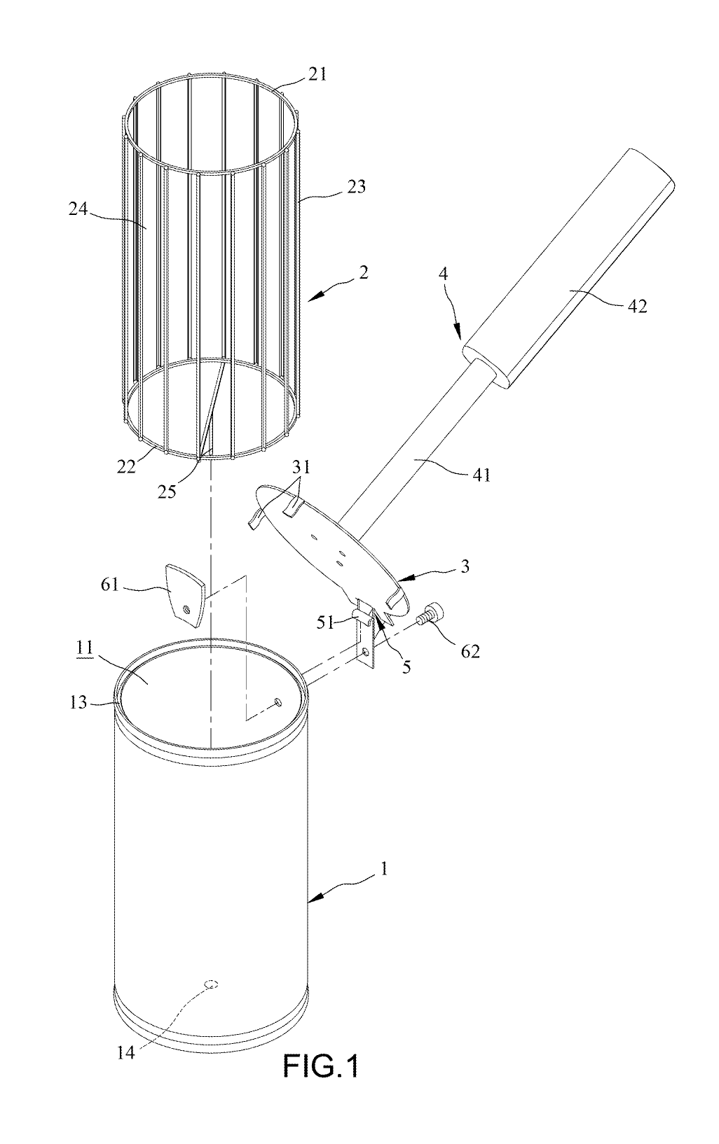

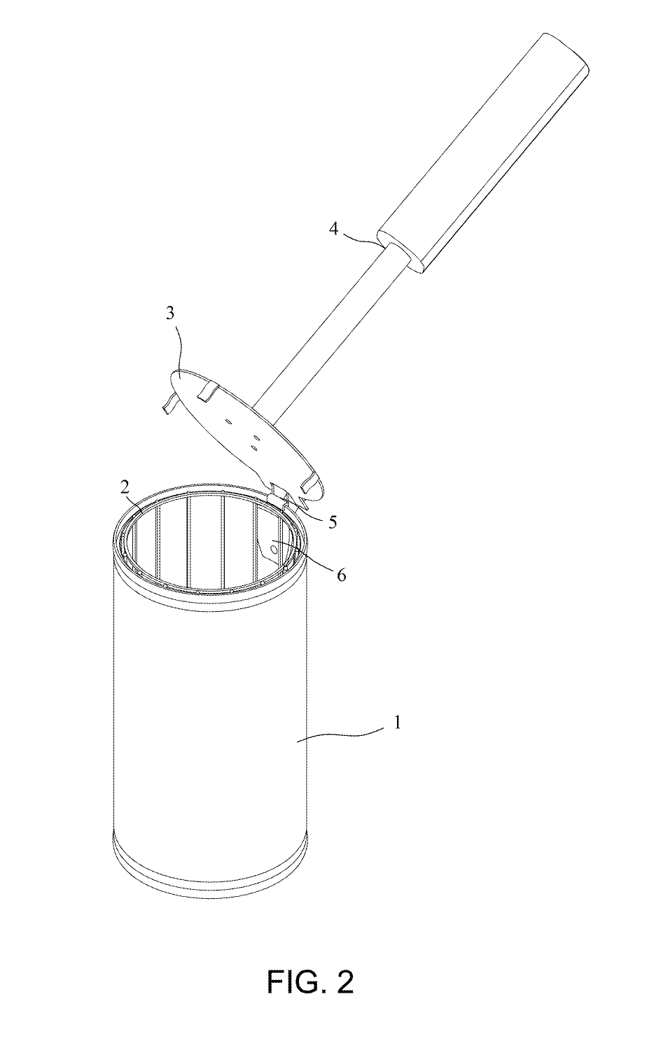

Referring to FIG. 1 to FIG. 3, FIG. 1 to FIG. 3 show the exploded view, the perspective view, and the sectional view of the portable anti-scorching roasting can in the present embodiment of the invention, respectively. The portable anti-scorching roasting can includes a can body 1, a segregating cage 2, a cover 3, and a handle 4.

The can body 1 has an open end 11 and a containing space 12. The can body 1 can be made from any container that has good heatproof properties. In the present embodiment, the can body 1 is made from a pop-top can. By removing the cover of the pop-top can, the can body 1, which includes the open end 11 and the containing space 12, is thereby formed. Because the can body 1 is disposable, the user can easily replace an old can body 1 with a new can body 1. An inner rim 13 is formed at the open end 11 of the can body 13. Furthermore, the grease discharge hole 14 is disposed at the center of the bottom surface of the can body 1.

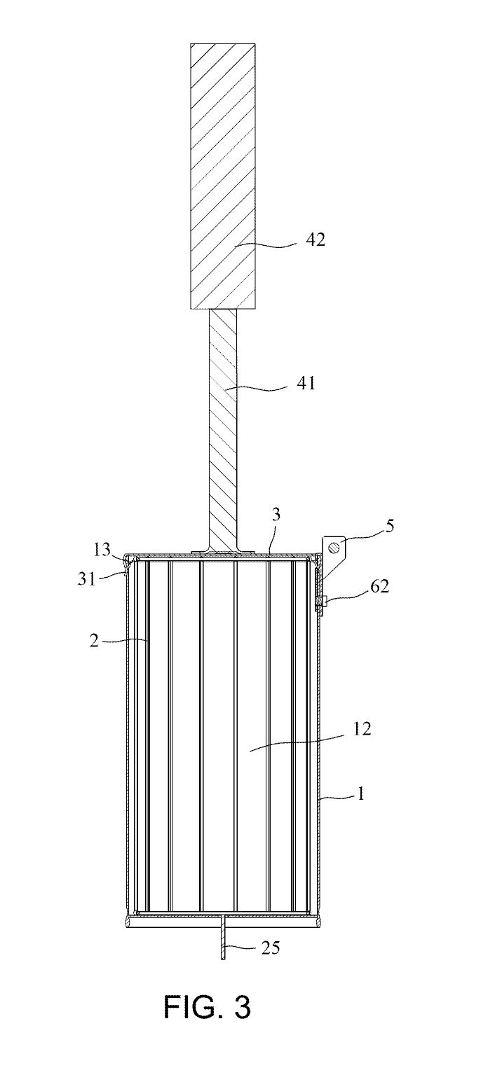

The segregating cage 2 is used to contain the foodstuff. Furthermore, the segregating cage 2 can prevent the foodstuff from being in direct contact with the inner surface of the can body 1, so that the inner surface is not inadvertently stuck and coated with the sauce dripped from the foodstuff. In the present embodiment, the segregating cage 2 is made by bending and welding a plurality of stainless steel bars. The segregating cage includes two circular ends 21, 22, between which a plurality of bars 23 is disposed. The oil or grease produced during the roasting period is dropped through an opening 24 into the bottom of the can body 1. The height of the bars 23 is substantially equal to the distance between the bottom of the can body 1 and the inner rim 13. A longitudinal rod 25 is located at the center of one circular end 22. As shown in the sectional view in FIG. 3, the circular end 21 of the segregating cage 2 is contacted with the inner rim 13 of the open end 11 so that there is a clearance between the bar 23 of the segregating cage 2 and the inner surface of the can body 1. Therefore, the foodstuff is not contacted with the inner surface of the can body 1. The longitudinal rod 25 is passed through the grease discharge hole 14 of the can body 1. The segregating cage can also be made of a meshed metal plate.

The cover 3 is a piece of sheet metal having a diameter larger than the open end 11 of the can body 1. A plurality of pressing elements 31 is integrally formed around the rim of the cover 3. The portable anti-scorching roasting can further includes a pivoting element 5 which connects the cover 3 and the can body 1. By means of the pivoting element 5, the cover 3 can be used to open or close the can body 1 at the open end 11 of the can body 1. The pivoting element 5 includes a hook portion 51. The hook portion 51 is hooked on the outer rim of the open end 11 of the can body 1, so that the pivoting element 5, which is connected with the cover 3, is fastened on the can body 1. The portable anti-scorching roasting can further includes a combining element 6. The combining element 6 includes a nut 61 and a bolt 62. The nut 61 is placed below the inner rim 13 and against the inner surface of the can body 1. The bolt 62, which is passed through the pivoting element 5 and the can body 1, is assembled with the nut 61, so that the pivoting element 5 connected with the cover 3 is fixed on the can body 1. When the cover 3 closes or seals the open end of the cover 3, the pressing member 31 is pressed against the rim of the open end 11, so that the open end 11 is sealed completely. When the can body 1 is no longer suitable for use anymore, the user just loosens the bolt 62 and detaches the pivoting element 5 from the old can body 1, and then attaches the existing pivoting element 5 with a new can body 1. The user can easily assemble and disassemble the nut 61 and the bolt 62 by using a screwdriver.

In the present embodiment, the handle 4 includes a connecting portion 41 and a handle grip 42. The connecting portion 41 is substantially straight and can be made of metal. The handle grip 42 can be made of wood, Bakelite, or other similar material. One end of the connecting portion 41 can be joined to the cover 3 by means of spot welding method, so that the handle 4 is fixed substantially perpendicularly at the center of the cover 3. The shape of the handle 4 can be made in the form of another shape, for example, in the form of an ergonomic shape (not shown).

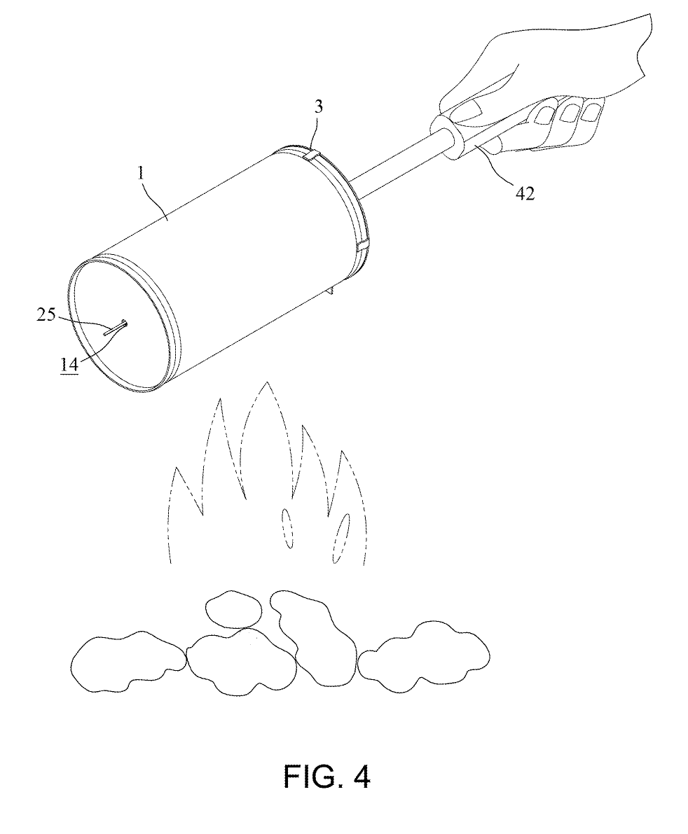

Please refer to FIG. 4, FIG. 4 shows the use of the portable anti-scorching roasting can in the present embodiment. In the barbecue activity, the user holds the handle grip 42 to maintain the can body 1 in a horizontal direction. The can body 1 is held above the fire. The foodstuff inside the can body 1 is contacted with the segregating cage 2 (as shown in FIG. 3). The grease which is dripped from the foodstuff is dropped through the openings into the inner surface of the can body 1, and then is flowed along the inner surface into the discharge hole 14. The can body 1 is sealed completely by the cover 3, so that the foodstuff is cooked thoroughly by roasting at relatively higher temperatures. Because of not being in contact with the fire, the foodstuff is not easily scorched so as to produce carcinogens. After the foodstuff is cooked thoroughly, the user can then open the cover and take out the cooked foodstuff.

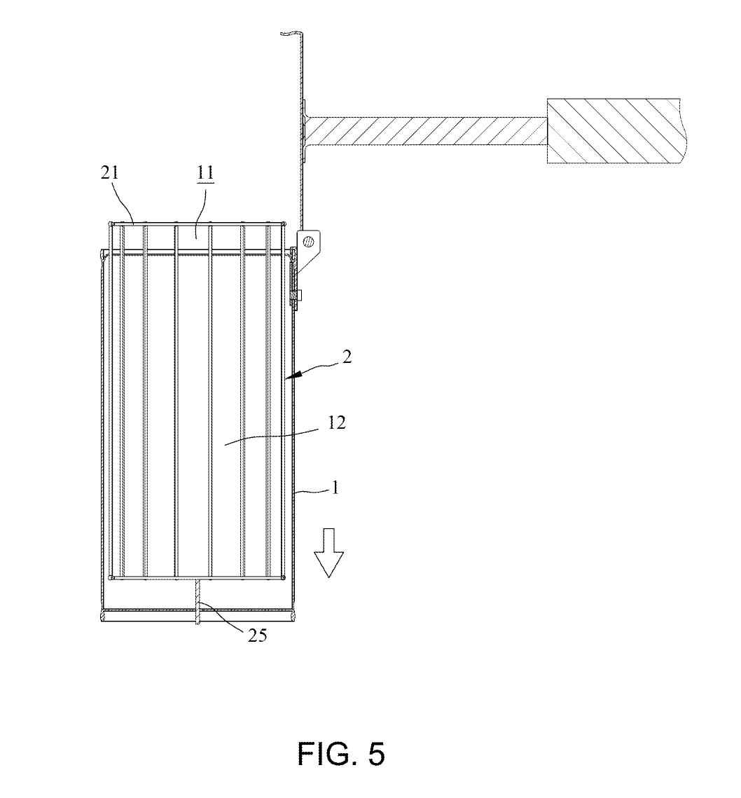

As shown in FIG. 5, if the user perpendicularly or vertically taps the can body 1 against the ground, the longitudinal rod 25 will be abutted and pushed against the ground, and the circular end 21 of the segregating cage 2 will be ejected from the open end 11 of the can body 1, and then the segregating cage 2 can be clamped and taken out by a clamping tool. Thereafter, the user can wash and reuse the segregating cage 2 or instead replace it with a new one.

In the above embodiment, the segregating cage 2 does not have a bottom surface. However, the bottom surface (not shown) of the segregating cage 2 can be formed by means of several stainless bars. After the can body is tapped perpendicularly against the ground or any solid surface, the foodstuff can be fallen on the bottom surface of the segregating cage 2. Therefore, the foodstuff can be taken out together with the segregating cage while being clamped. By using this method, the user can avoid being scalded while taking out the foodstuff.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. A portable anti-scorching roasting can, comprising:
a can body, the can body having an open end and a containing space;
at least one segregating cage, the segregating cage having a plurality of openings, and the segregating cage located in the containing space and used to contain the foodstuff;
a cover;
a pivoting element, the pivoting element located between the cover and the can body;
a combining element, the combining element located between the pivoting element and the can body; and
a handle, having a connecting portion and a handle grip, the connecting portion connected to the cover;
wherein the cover is open or closed at the open end of the can body by means of the pivoting element, the pivoting element is connected to the cover, and the pivoting element is secured into the can body by means of the combining element, and the handle grip is made of a thermal insulating material.

2. The portable anti-scorching roasting can of claim 1, wherein a grease discharge hole is formed on a bottom surface of the can body.

3. The portable anti-scorching roasting can of claim 2, wherein the shape and height of the segregating cage is corresponding to the shape and height of the containing space, an inner rim is formed at an open end of the can body, one end of the segregating cage is contacted with the inner rim so that a clearance exists between the segregating cage and the can body.

4. The portable anti-scorching roasting can of claim 3, wherein the segregating cage has two circular ends, between which a plurality of bars is placed, each of the openings is disposed between a pair of consecutive bars, a longitudinal rod is disposed at the center of one end of the segregating cage, the longitudinal rod is passed through the grease discharge hole.

5. The portable anti-scorching roasting can of claim 4, wherein the combining element includes a nut and a bolt, the nut is placed below the inner rim and against the inner surface of the can body, the bolt is passed through the pivoting element and the can body, and is assembled with the nut.

6. The portable anti-scorching roasting can of claim 1, wherein the handle is substantially straight and the connecting portion is connected perpendicularly to the cover.
